(19) United States
(12) Patent Application Publication
(10) Pub. No.: US 2020/0218573 A1
(43) Pub. Date: Jul. 9, 2020

(54) MEMORY MANAGEMENT METHOD, ELECTRONIC APPARATUS, AND STORAGE DEVICE

(71) Applicant: AutoChips Inc., Hefei (CN)

(72) Inventor: Daan Sun, Hefei (CN)

(21) Appl. No.: 16/438,489

(22) Filed: Jun. 12, 2019

(30) Foreign Application Priority Data
Jan. 4, 2019 (CN) 201910009079.7

(51) Int. Cl. G06F 9/50; G06F 11/34; G06F 11/30; G06F 12/06

(52) U.S. Cl. CPC G06F 9/5016; G06F 9/5022; G06F 12/0646; G06F 11/3037; G06F 11/3442

(57) ABSTRACT

The present disclosure discloses a memory management method, an electronic apparatus and a device with a storage function. The method includes: acquiring a currently required reserved memory value of a component/application, where the reserved memory is a part of physical memory reserved by an operating system for the component/application and not to be mapped into running memory; judging whether the currently required reserved memory value is smaller than an allocated reserved memory value, where the allocated reserved memory value is a reserved memory size allocated by the operating system to the component/application; and when the currently required reserved memory value is smaller than the allocated reserved memory value, recovering redundant reserved memory and reallocating the recovered reserved memory for use as running memory. In the above manner, the present disclosure can increase a utilization ratio of memory.

### CROSS-REFERENCE TO RELATED APPLICATIONS

The present application claims foreign priority of Chinese Patent Application No. 201910009079.7, filed on Jan. 4, 2019 in the China National Intellectual Property Administration, the entire contents of which are hereby incorporated by reference.

### TECHNICAL FIELD

The present disclosure relates to the technical field of computers, particularly to a memory management method, an electronic apparatus, and a device with a storage function.

### BACKGROUND

An operating system, as core software of an apparatus, manages hardware and software resources of the apparatus and maintains them at normal conditions. In hardware physical resources managed by the operating system, memory is an indispensably essential component. Memory viewed in a current operating system is total memory available when the operating system runs program, i.e., running memory, the value of which is smaller than physical memory that can be actually used by the operating system. For example, with regard to 1 G of physical memory, running memory viewed by the operating system is 0.9 G, while the memory of 0.1 G is just reserved memory defined by the operating system. Reserved memory is a consecutive memory area written in a DTS (Device Tree Source) file and is allocated in advance before startup of the operating system. At the time of the startup of the operating system, the area is not subjected to address mapping, i.e., is transparent to the operating system, and is provided only for dedicated components/applications, and will not be allocated by the operating system to other components/applications.

During a long-term research and development process, the inventor of the present disclosure has found that the current operating system uses reserved memory in a single mode. When the operating system allocates a segment of reserved memory to a component/application, no other component/application can use the block of memory until termination of the operating system, thereby resulting in waste of memory resources, decrease in running memory and increase in probability of errors due to insufficient memory.

### SUMMARY

The technical problem to be mainly solved by the present disclosure is to provide a memory management method, an electronic apparatus, and a device with a storage function, which can increase a utilization ratio of memory.

To solve the above mentioned problem, a technical scheme adopted by the present disclosure is to provide a memory management method. The memory management method includes: acquiring a currently required reserved memory value of a component/application, the reserved memory being a part of physical memory which is reserved by an operating system for the component/application and is not to be mapped into running memory; judging whether the currently required reserved memory value is smaller than an allocated reserved memory value, the allocated reserved memory value being a reserved memory size allocated by the operating system to the component/application; and when the currently required reserved memory value is smaller than the allocated reserved memory value, recovering redundant allocated reserved memory, and reallocating the recovered reserved memory for use as running memory.

To solve the above mentioned problem, a technical scheme adopted by the present disclosure is to provide an electronic apparatus. The electronic apparatus includes a display screen, a processor and a memory, the processor being coupled to the memory, the memory being configured to store an operating system, the processor being configured to: acquire a currently required reserved memory value of a component/application, the reserved memory being a part of physical memory which is reserved by an operating system for the component/application and is not to be mapped into running memory; judge whether the currently required reserved memory value is smaller than an allocated reserved memory value, the allocated reserved memory value being a reserved memory size allocated by the operating system to the component/application; and when the currently required reserved memory value is smaller than the allocated reserved memory value, recovering redundant allocated reserved memory, and reallocating the recovered reserved memory for use as running memory. The display screen is configured to display a value of current running memory.

To solve the above mentioned problem, a technical scheme adopted by the present disclosure is to provide a device with a storage function. The device has program stored therein, the program, when executed, configured to implement a memory management method. The method includes: acquiring a currently required reserved memory value of a component/application, the reserved memory being a part of physical memory which is reserved by an operating system for the component/application and is not to be mapped into running memory; judging whether the currently required reserved memory value is smaller than an allocated reserved memory value, the allocated reserved memory value being a reserved memory size allocated by the operating system to the component/application; and when the currently required reserved memory value is smaller than the allocated reserved memory value, recovering redundant allocated reserved memory, and reallocating the recovered reserved memory for use as running memory.

The present disclosure has the following advantageous effects. The present disclosure provides a memory management method, wherein actual reserved memory size required to be used by different components/applications in the system is detected during the startup process of the operating system, and if the actually required reserved memory is smaller than memory allocated by the system, releasing redundant reserved memory and reallocating the recovered reserved memory for use as running memory, thereby increasing total available memory of the system and increasing a utilization ratio of the system memory.

### BRIEF DESCRIPTION OF THE DRAWINGS

FIG. 1 is a flow diagram of a first embodiment of a memory management method according to the present disclosure.

FIG. 2 is a flow diagram of a second embodiment of a memory management method according to the present disclosure.

FIG. 3 is a flow diagram of a third embodiment of a memory management method according to the present disclosure.

FIG. 4 is a structural diagram of a first embodiment of an electronic apparatus according to the present disclosure.

FIG. 5 is a structural diagram of a first embodiment of a device with a storage function according to the present disclosure.

### DETAILED DESCRIPTION

In order to make the object, technical solutions and effects of the present disclosure clearer, a detailed description will be further made below with reference to the accompanying drawings and the embodiments.

The present disclosure provides a memory management method, which is at least applied to memory management by an operating system of a vehicle, a computer or a mobile apparatus. In the operating system, physical memory that can be used is definite and is determined by an actual physical apparatus, i.e., a memory. If the physical apparatus is not replaced, the physical memory that can be used will remain unchanged. For example, a 1 G memory bank (Random Access Memory, RAM) means 1 G physical memory, and the value of which will remain unchanged.

When being run, the operating system uses physical memory in two parts, i.e., running memory and reserved memory. The reserved memory is space reserved by the operating system for dedicated components/applications to store data, and this part of memory will not be mapped into running memory. Dedicated components/applications are some key hardware or software applications, including hardware devices such as monitors, hard disks, graphics cards, and network cards, etc.; necessary software applications such as image scaling, image de-noising, and car reversing, etc. For example, a display component (framebuffer) needs to use reserved memory to save data displayed on the screen. At the time of the startup of the operating system, the size of the reserved memory required to be allocated is obtained by reading the DTS file. When carrying out mapping of running memory, the area is ignored, that is, the running memory of the operating system will reduce the size of the reserved memory, as compared with the physical memory. In the system application, the memory requested to be allocated occupies running memory, and does not involve reserved memory, such as malloc, kalloc and other function API (Application Programming Interface).

In order to achieve compatibility of the electronic apparatus to support better hardware component performance or software application, it is customary to allocate a segment of space in reserved memory for use according to maximum memory space used by the component/application. However, the reserved memory actually used by the component/application is not necessarily required to be so large, and will have some unoccupied space. After the current operating system allocates reserved memory for use by a dedicated component/application, even if there is unoccupied space in the reserved memory, a recovery mechanism will still not be initiated for the allocated reserved memory, which will result in insufficient utilization of the allocated reserved memory and waste of the memory resources. As a matter of fact, the system is capable of recovering the reserved memory in a certain manner.

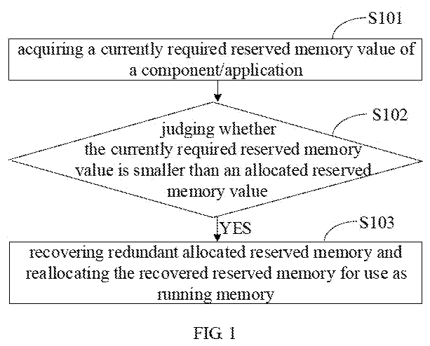

On the basis of the above, the present disclosure provides a memory management method, in which reserved memory can be recovered for use by the system, thereby improving utilization of the reserved memory and increasing the running memory of the system for use by the system. Reference is made to FIG. 1, which is a flow diagram of a first embodiment of a memory management method according to the present disclosure. In this embodiment, the memory management method includes the following operations.

S101: Acquiring a currently required reserved memory value of a component/application.

The currently required reserved memory value refers to a reserved memory size actually required to be used for running the components/application. Application Programming Interface function (API function) can be used to calculate the currently required reserved memory value of the component/application. In particular, space size of reserved memory required to be used to store the data can be calculated according to data types of different components/applications.

S102: Judging whether the currently required reserved memory value is smaller than an allocated reserved memory value.

The allocated reserved memory value is a reserved memory size allocated by the operating system to the component/application.

S103: If the currently required reserved memory value is smaller than the allocated reserved memory value, recovering redundant allocated reserved memory and reallocating the recovered reserved memory for use as running memory.

Allocating reserved memory of a size of the currently required reserved memory value to the component/application may refer to continuing to use the allocated reserved memory, with redundant reserved memory released and recovered; or may refer to allocating afresh a block of new reserved memory of a target size to the component/application, and releasing and recovering the allocated reserved memory as a whole; or refers to allocating afresh a block of new memory space of a target size in the running memory to the component/application, and modifying this memory area into reserved memory, while releasing and recovering the allocated reserved memory as a whole. In this way can memory fragmentation be reduced, thereby further increasing a utilization ratio of the memory.

In one embodiment, if the currently required reserved memory value is equal to the allocated reserved memory value, it will not be needed to change the allocation of the reserved memory. If the currently required reserved memory value is larger than the allocated reserved memory value, the operating system is shown to be non-supportive of or non-compatible with the component/application. In this case, the system will fail and will not start properly.

In one embodiment, the allocated reserved memory value is an initial reserved memory size allocated by the operating system to the component/application for the first time. The reserved memory allocated by the system has already been written in the DTS file. At the time of the startup of the system, the reserved memory size required to be allocated is acquired by reading the DTS file, and the memory space is reserved.

With a display component as an example, the display component needs to use reserved memory to save data displayed on the screen. Generally, a size of the saved data is associated with a resolution of the screen. If the resolution of the screen is great, the reserved memory used will be relatively large. In order to make it possible to support greater resolution, the system will allocate relatively large reserved memory in advance, of which the size FB_MAX has been written in DTS. When the system starts, memory of the FB_MAX size is removed from physical memory.

Generally, in a predetermined hardware and software system, the screen resolution is definite, and memory space required to be used is also already definite. Therefore, when the system starts, a currently required reserved memory size FB_SIZE of the display component can be acquired. Specifically, the screen resolution can be acquired through the API, and then the currently required reserved memory size FB_SIZE is calculated by using a predetermined formula. The screen resolution includes a horizontal resolution w of the screen, a vertical resolution h, a bit depth bitcount, and the like; and the currently required reserved memory size can be calculated using the formula FB_SIZE=w*h*(bitcount/8)*n, where n represents the number to be needed.

The currently required reserved memory size FB_SIZE is compared with the allocated reserved memory size FB_MAX. If the currently required reserved memory size FB_SIZE is smaller than the allocated reserved memory size FB_MAX, redundant reserved memory (FB_MAX−FB_SIZE) will be released and automatically recovered by the system.

In one embodiment, the recovered reserved memory will be reallocated for use as running memory. In the above embodiment, after the reserved memory is reallocated, running memory of the system will increase by a value (FB_MAX−FB_SIZE); and when other applications of the system create a segment of area through memory allocation API (for example, malloc, kalloc, etc.), the system will automatically allocate the released unoccupied area for use by other applications.

In one embodiment, in order to maximize the running memory, detection of unoccupied space is performed on reserved memory of each of dedicated components/applications at the time of system startup, and redundant reserved memory is released. In other embodiments, an unoccupied value of the running memory may also be detected first. If the unoccupied value of the current running memory is greater than a preset threshold, it is shown that the current running memory is sufficient for use, without involving a need to release the reserved memory; and if the unoccupied value of the current running memory is smaller than the preset threshold, it is shown that the current running memory is insufficient, such that detection of unoccupied space can be performed on the reserved memory and the reserved memory is released as much as possible to increase the running memory and improve memory utilization.

In one embodiment, unoccupied reserved memory may be detected only at the time of system startup, and only a currently required reserved memory value is detected once for a certain component/application, and redundant reserved memory is released once. The reserved memory of the component/application is no longer changed until the system is shut down or restarted, that is, the release of the reserved memory is irreversible.

However, if it is needed to replace some hardware (charged or uncharged) or increase/decrease software during the running of the system, corresponding reserved memory may also be changed. If detection is carried out only once, it will be detrimental to running of the component/application. Therefore, in another embodiment, it is possible to dynamically perform detection management on the reserved memory of the component/application.

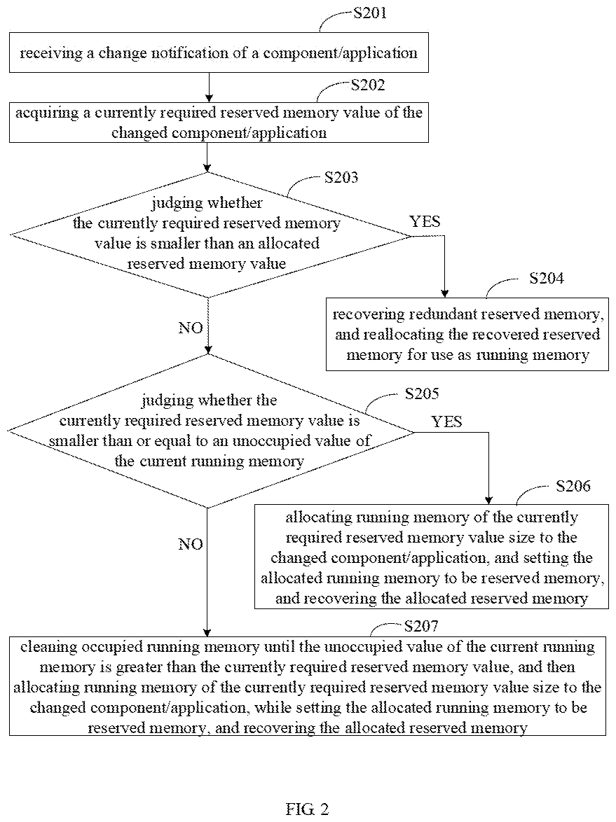

Reference is made to FIG. 2, which is a flow diagram of a second embodiment of a memory management method according to the present disclosure. In this embodiment, the memory management method includes the following operations.

S201: Receiving a change notification of a component/application.

During the running of the system, if some hardware components are replaced, or software application functions are added or deleted, the operating system is notified that the components/applications have been changed, memory required may be changed, and detection and allocation should be performed anew on the reserved memory.

S202: Acquiring a currently required reserved memory value of the changed component/application.

The currently required reserved memory size of the component/application can be acquired via API and calculated according to a predetermined formula. With a display component as an example, after the display is replaced, the resolution of the screen may be changed, and a currently required reserved memory size MOD_SIZE of the changed component/application is calculated using the formula MOD_SIZE=w*h*(bitcount/8)*n, where n represents the number to be needed.

S203: Judging whether the currently required reserved memory value is smaller than an allocated reserved memory value.

The allocated reserved memory value is a reserved memory size after an allocation is changed, i.e., a reserved memory size FB_SIZE already reallocated by the operating system according to the actually required reserved memory size of the component/application before the change.

If the MOD_SIZE is smaller than FB_SIZE, operation S204 is performed: recovering redundant reserved memory (FB_SIZE−MOD_SIZE), and reallocating the recovered reserved memory for use as running memory. That is, the previously allocated reserved memory area continues to be used, and reserved memory space (FB_SIZE−MOD_SIZE) is released and recovered, such that the running memory increases by (FB_SIZE−MOD_SIZE), which can be allocated for use by other components/applications.

If MOD_SIZE is greater than FB_SIZE, operation S205 is performed: judging whether the currently required reserved memory value MOD_SIZE is smaller than or equal to an unoccupied value of the current running memory.

If MOD_SIZE is smaller than or equal to the unoccupied value of the current running memory, operation S206 is performed: allocating running memory of the currently required reserved memory value size MOD_SIZE to the changed component/application, and setting the allocated running memory to be reserved memory, and recovering the allocated reserved memory FB_SIZE. That is, memory space of a target size in running memory is allocated afresh directly to the component/application, and the running memory is set to be reserved memory, and the previously allocated reserved memory FB_SIZE as a whole is recovered and used as running memory. In this way, the reserved memory of the component/application can be satisfied, and memory fragmentation can be reduced.

If MOD_SIZE is greater than the unoccupied value of the current running memory, operation S207 is performed: cleaning occupied running memory until the unoccupied value of the current running memory is greater than the currently required reserved memory value MOD_SIZE, and then allocating running memory of the currently required reserved memory value size MOD_SIZE to the changed component/application, while setting the allocated manning memory to be reserved memory, and recovering the allocated reserved memory FB_SIZE. Through the system's API, some abandoned applications (APPs) can be shut down, or some other lower-priority applications can be shut down, thereby recovering, via cleaning, enough running memory for allocation by the operating system. Then, the operating system directly allocates afresh memory space of the target size MOD_SIZE in the running memory to the component/application, and sets the running memory to be reserved memory, as well as recovers the previously allocated reserved memory FB_SIZE as a whole for use as running memory.

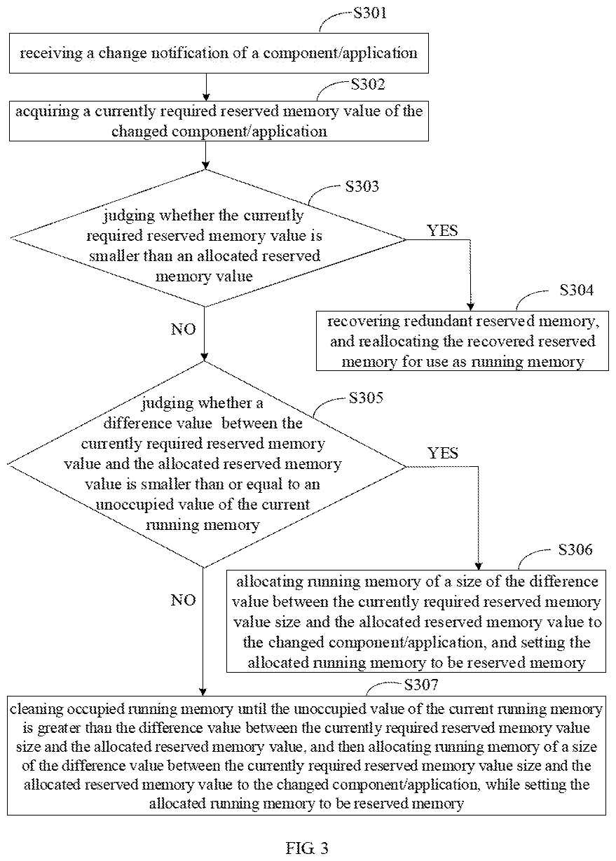

Reference is made to FIG. 3, which is a flow diagram of a third embodiment of a memory management method according to the present disclosure. In this embodiment, a memory management method includes the following operations.

S301: Receiving a change notification of a component/application.

During the running of the system, if some hardware components are replaced, or software application functions are added or deleted, the operating system is notified that the components/applications have been changed, memory required may be changed, and detection and allocation should be performed anew on the reserved memory.

S302: Acquiring a currently required reserved memory value of the changed component/application.

The currently required reserved memory size of the component/application can be acquired through API and calculated according to a predetermined formula. With a display component as an example, after the display is replaced, the resolution of the screen may be changed, and a currently required reserved memory size MOD_SIZE of the changed component/application is calculated using the formula MOD_SIZE=w*h*(bitcount/8)*n, where n represents the number to be needed.

S303: Judging whether the currently required reserved memory value smaller than an allocated reserved memory value.

The allocated reserved memory value is a reserved memory size after an allocation is changed, i.e., a reserved memory size FB_SIZE already reallocated by the operating system according to the actually required reserved memory size of the component/application before the change.

If MOD_SIZE is smaller than FB_SIZE, operation S304 is performed: recovering redundant reserved memory (FB_SIZE−MOD_SIZE), and reallocating the recovered reserved memory for use as running memory. That is, the previously allocated reserved memory area continues to be used, and reserved memory space (FB_SIZE−MOD_SIZE) is released and recovered, such that the running memory increases by (FB_SIZE−MOD_SIZE), which can be allocated for use by other components/applications.

If MOD_SIZE is greater than FB_SIZE, operation S305 is performed: judging whether a difference value, i.e., (MOD_SIZE−FB_SIZE), between the currently required reserved memory value and the allocated reserved memory value is smaller than or equal to an unoccupied value of the current naming memory.

If MOD_SIZE−FB_SIZE is smaller than or equal to the unoccupied value of the current running memory, operation S306 is performed: allocating running memory of a size of the difference value (MOD_SIZE−FB_SIZE) between the currently required reserved memory value size and the allocated reserved memory value to the changed component/application, and setting the allocated running memory to be reserved memory. That is, memory space of some size in running memory is allocated afresh to the component/application to compensate for the insufficient reserved memory, and the running memory is set to be reserved memory. Prior to performing the operation S306, it is also possible to first judge whether there is consecutive unoccupied memory space greater than the difference value (MOD_SIZE−FB_SIZE) size in a periphery of the allocated reserved memory block. If yes, when the running memory is set to be reserved memory, it is set to be consecutive to the previously allocated reserved memory. If no, areas of the memory blocks where different components/applications in the reserved memory lie are readjusted, such that enough consecutive unoccupied memory space exists in the periphery of the allocated reserved memory block.

If MOD_SIZE−FB_SIZE is greater than the unoccupied value of the current running memory, operation S307 is performed: cleaning occupied running memory until the unoccupied value of the current running memory is greater than the difference value (MOD_SIZE−FB_SIZE) between the currently required reserved memory value size and the allocated reserved memory value, and then allocating running memory of a size of the difference value between the currently required reserved memory value size and the allocated reserved memory value to the changed component/application, while setting the allocated running memory to be reserved memory. Specific operation can be referred to in the description of the above embodiments, and thus details thereof are not described herein.

Through the above method, the reserved memory can be dynamically adjusted to achieve reversibility of the reserved memory release, thereby making it possible to satisfy normal running of the component/application. For example, during running of different versions of software, in order to achieve software compatibility, it is customary to allocate a segment of space in reserved memory according to maximum memory space used by the software, and it is possible to release or increase the reserved memory according to differences in versions, to ensure that the reserved memory used by each version is positively associated with the version. The method provided by the present disclosure uses reserved memory and dynamically increases a size of the running memory of the system, to maximize the running memory and increase a utilization ratio of the memory. As the running memory of the system increases, there will be more software that can be run, and memory space which can be requested by the software increases, thus reducing the probability of errors due to failure of the software to request memory space.

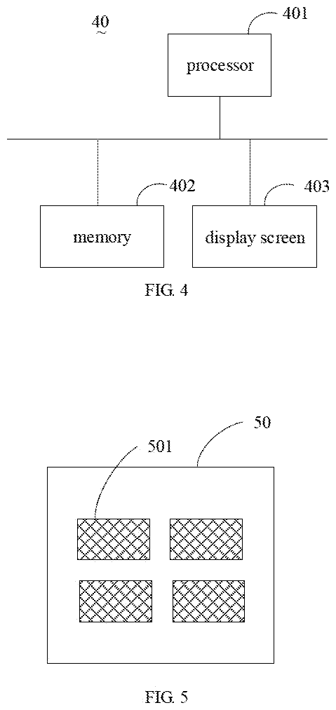

In view of the above, the present disclosure further provides an electronic apparatus. Reference is made to FIG. 4, which is a structural diagram of a first embodiment of the electronic apparatus according to the present disclosure. In this embodiment, the electronic apparatus 40 includes a processor 401 and a memory 402. The processor 401 is coupled to the memory 402. The memory 402 is configured to store an operating system. The electronic apparatus 40 may further include a display screen 403 coupled to the processor 401 and/or the memory 402. The processor 401 is configured to acquire a reserved memory value currently required by a component/application. The reserved memory is a part of physical memory which is reserved by the operating system for the component/application and is not to be mapped into running memory. A judgment is made as to whether the currently required reserved memory value is smaller than an allocated reserved memory value which is a reserved memory size allocated by the operating system to the component/application. If the currently required reserved memory value is smaller than the allocated reserved memory value, reserved memory of a size of the currently required reserved memory value is allocated to the component/application, and redundant allocated reserved memory is recovered. For detailed implementation, refer to the description of the above embodiments, and details are not described herein again. The electronic apparatus provided by the present disclosure is capable of implementing the above memory management method for improving memory utilization. The electronic apparatus can be a vehicle, a computer, a mobile phone, or the like. The display screen 403 can display a value of current running memory. It is understood that, by implementing the above memory management method, the value of current running memory may be dynamically changing. Therefore, by dynamically displaying the value of current running memory via the display screen 403, users can directly and intuitively see changes in running memory.

The present disclosure further provides a device with a storage function. Reference is made to FIG. 5, which is a structural diagram of a first embodiment of a storage device with a storage function according to the present disclosure. In this embodiment, the storage device 50 stores program 501 therein, which program 501, when executed, is configured to implement the memory management method described above. The specific working process is the same as that in the foregoing method embodiments, and therefore is not described herein. For details, refer to the description of the corresponding method operations. The device with a storage function can be a portable storage medium such as a USB flash drive, an optical disk, a mobile hard disk, a Read-Only Memory (ROM), a Random Access Memory (RAM), a magnetic disk, or other medium capable of storing program codes, and can also be a terminal, a server, or the like.

In the several embodiments provided by the present disclosure, it should be understood that, the disclosed system, device, and method may be implemented in other manners. For example, the device embodiment described above is merely illustrative. For example, division of the modules or units is nothing but a logical function division. In actual implementation, there can be other manners of division, for example, multiple units or components may be combined, or may be integrated into another system, or some features can be ignored or not executed. In addition, coupling or direct coupling or communication connection therebetween as shown or discussed may be indirect coupling or communication connection of devices or units through some interfaces, and may be in an electrical, mechanical or other form.

The units described as separate components may or may not be physically separated, and the components displayed as units may or may not be physical units, i.e., may be located in one place, or may be distributed on multiple network units. Some or all of the units may be selected according to actual needs to achieve the purpose of the solution of the present embodiment.

Furthermore, respective functional units in each embodiment of the present disclosure may be integrated into one processing unit, or each unit may exist alone physically, or two or more units may be integrated into one unit. The above integrated unit can be implemented in the form of hardware or in the form of a software functional unit.

The integrated unit, if implemented in the form of a software functional unit and sold or used as an independent product, may be stored in a computer-readable storage medium. Based on such understanding, the technical solution of the present disclosure in its essence, the part which is contributive to the prior art, or all or part of the technical solution, may be embodied in the form of a software product. The computer software product, which is stored in a storage medium, comprises a plurality of instructions used to cause a computer apparatus (which may be a personal computer, a server, or a network apparatus, etc.) or a processor to perform all or part of the operations of the method according to the various embodiments of the present disclosure.

The foregoing are only embodiments of the present disclosure, and are not intended to limit the patent scope of the present disclosure. Any equivalent structure or equivalent flow transformation made based on the description and drawings of the present disclosure, or applied directly or indirectly to other related technical fields, shall be likewise included in the scope of patent protection of the present disclosure.

What is claimed is:

1. A memory management method, comprising:
acquiring a currently required reserved memory value of a component/application, the reserved memory being a part of physical memory which is reserved by an operating system for the component/application and is not to be mapped into running memory;
judging whether the currently required reserved memory value is smaller than an allocated reserved memory value, the allocated reserved memory value being a reserved memory size allocated by the operating system to the component/application; and
when the currently required reserved memory value is smaller than the allocated reserved memory value, recovering redundant allocated reserved memory, and reallocating the recovered reserved memory for use as running memory.

2. The memory management method according to claim 1, wherein the allocated reserved memory value is an initial reserved memory size allocated by the operating system to the component/application for the first time.

3. The memory management method according to claim 1, wherein the allocated reserved memory value is a reserved memory size already reallocated by the operating system according to an actually required reserved memory size of the component/application.

4. The memory management method according to claim 3, wherein said acquiring a currently required reserved memory value of a component/application comprises:
receiving a change notification of the component/application; and
acquiring the currently required reserved memory value of the changed component/application.

5. The memory management method according to claim 4, wherein the method further comprises:
when the currently required reserved memory value of the changed component/application is larger than the allocated reserved memory value, judging whether the currently required reserved memory value is smaller than or equal to an unoccupied value of current running memory; and
when the currently required reserved memory value is smaller than or equal to the unoccupied value of the current running memory, allocating running memory of a size of the currently required reserved memory value to the changed component/application, setting the allocated running memory to be reserved memory, and recovering the allocated reserved memory.

6. The memory management method according to claim 5, wherein the method further comprises:
when the currently required reserved memory value is larger than the unoccupied value of the current running memory, cleaning occupied running memory until the unoccupied value of the current running memory is larger than the currently required reserved memory value, reallocating running memory of a size of the currently required reserved memory value to the changed component/application, and meanwhile setting the allocated running memory to be reserved memory and recovering the allocated reserved memory.

7. The memory management method according to claim 4, wherein the method further comprises:
when the currently required reserved memory value of the changed component/application is larger than the allocated reserved memory value, judging whether a difference value between the currently required reserved memory value and the allocated reserved memory value is smaller than or equal to an unoccupied value of current running memory; and
when the difference value between the currently required reserved memory value and the allocated reserved memory value is smaller than or equal to the unoccupied value of the current running memory, allocating running memory of a size of the difference value between the currently required reserved memory value and the allocated reserved memory value to the changed component/application and setting the allocated running memory to be reserved memory.

8. The memory management method according to claim 7, wherein the method further comprises:
when the difference value between the currently required reserved memory value and the allocated reserved memory value is larger than the unoccupied value of the current running memory, cleaning occupied running memory until the unoccupied value of the current running memory is larger than the difference value between the currently required reserved memory value and the allocated reserved memory value, reallocating running memory of a size of the difference value between the currently required reserved memory value and the allocated reserved memory value to the changed component/application, and meanwhile setting the allocated running memory to be reserved memory.

9. An electronic apparatus, comprising a display screen, a processor and a memory, the processor being coupled to the memory, the memory being configured to store an operating system, the processor being configured to:
acquire a currently required reserved memory value of a component/application, the reserved memory being a part of physical memory which is reserved by an operating system for the component/application and is not to be mapped into running memory;
judge whether the currently required reserved memory value is smaller than an allocated reserved memory value, the allocated reserved memory value being a reserved memory size allocated by the operating system to the component/application; and
when the currently required reserved memory value is smaller than the allocated reserved memory value, recovering redundant allocated reserved memory, and reallocating the recovered reserved memory for use as running memory;
wherein the display screen is configured to display a value of current running memory.

10. The electronic apparatus according to claim 9, wherein the allocated reserved memory value is an initial reserved memory size allocated by the operating system to the component/application for the first time, or the allocated reserved memory value is a reserved memory size already reallocated by the operating system according to an actually required reserved memory size of the component/application.

11. The electronic apparatus according to claim 9, wherein the allocated reserved memory value is a reserved memory size already reallocated by the operating system according to an actually required reserved memory size of the component/application, and acquiring a currently required reserved memory value of a component/application comprises:
receiving a change notification of the component/application; and
acquiring the currently required reserved memory value of the changed component/application.

12. The electronic apparatus according to claim 11, wherein the processor is further configured to:
when the currently required reserved memory value of the changed component/application is larger than the allocated reserved memory value, judge whether the currently required reserved memory value is smaller than or equal to an unoccupied value of current running memory;
when the currently required reserved memory value is smaller than or equal to the unoccupied value of the current running memory, allocating running memory of a size of the currently required reserved memory value to the changed component/application, set the allocated running memory to be reserved memory, and recovering the allocated reserved memory.
when the currently required reserved memory value is larger than the unoccupied value of the current running memory, clean occupied running memory until the unoccupied value of the current running memory is larger than the currently required reserved memory value, reallocate running memory of a size of the currently required reserved memory value to the changed component/application, and meanwhile set the allocated running memory to be reserved memory and recover he allocated reserved memory.

13. A device with a storage function, wherein the device has program stored therein, the program, when executed, configured to implement a memory management method, wherein the method comprises:
acquiring a currently required reserved memory value of a component/application, the reserved memory being a part of physical memory which is reserved by an operating system for the component/application and is not to be mapped into running memory;
judging whether the currently required reserved memory value is smaller than an allocated reserved memory value, the allocated reserved memory value being a reserved memory size allocated by the operating system to the component/application; and
when the currently required reserved memory value is smaller than the allocated reserved memory value, recovering redundant allocated reserved memory, and reallocating the recovered reserved memory for use as running memory.

14. The device with a storage function according to claim 13, wherein the allocated reserved memory value is an initial reserved memory size allocated by the operating system to the component/application for the first time.

15. The device with a storage function according to claim 13, wherein the allocated reserved memory value is a reserved memory size already reallocated by the operating system according to an actually required reserved memory size of the component/application.

16. The device with a storage function according to claim 15, wherein said acquiring a currently required reserved memory value of a component/application comprises:
receiving a change notification of the component/application; and
acquiring the currently required reserved memory value of the changed component/application.

17. The device with a storage function according to claim 16, wherein the method further comprises:
when the currently required reserved memory value of the changed component/application is larger than the allocated reserved memory value, judging whether the currently required reserved memory value is smaller than or equal to an unoccupied value of current running memory; and
when the currently required reserved memory value is smaller than or equal to the unoccupied value of the current running memory, allocating running memory of a size of the currently required reserved memory value to the changed component/application, setting the allocated running memory to be reserved memory, and recovering the allocated reserved memory.

18. The device with a storage function according to claim 17, wherein the method further comprises:
when the currently required reserved memory value is larger than the unoccupied value of the current running memory, cleaning occupied running memory until the unoccupied value of the current running memory is larger than the currently required reserved memory value, reallocating running memory of a size of the currently required reserved memory value to the changed component/application, and meanwhile setting the allocated running memory to be reserved memory and recovering the allocated reserved memory.

19. The device with a storage function according to claim 16, wherein the method further comprises:
when the currently required reserved memory value of the changed component/application is larger than the allocated reserved memory value, judging whether a difference value between the currently required reserved memory value and the allocated reserved memory value is smaller than or equal to an unoccupied value of current running memory; and
when the difference value between the currently required reserved memory value and the allocated reserved memory value is smaller than or equal to the unoccupied value of the current running memory, allocating running memory of a size of the difference value between the currently required reserved memory value and the allocated reserved memory value to the changed component/application and setting the allocated running memory to be reserved memory.

20. The device with a storage function according to claim 19, wherein the method further comprises:
when the difference value between the currently required reserved memory value and the allocated reserved memory value is larger than the unoccupied value of the current running memory, cleaning occupied running memory until the unoccupied value of the current running memory is larger than the difference value between the currently required reserved memory value and the allocated reserved memory value, reallocating running memory of a size of the difference value between the currently required reserved memory value and the allocated reserved memory value to the changed component/application, and meanwhile setting the allocated running memory to be reserved memory.
